(19) United States
(12) Patent Application Publication
(10) Pub. No.: US 2009/0187476 A1
(43) Pub. Date: Jul. 23, 2009

(54) NETWORK TRANSACTION INTERMEDIATING METHODS, AND NETWORK PLATFORM THEREFOR

(75) Inventor: Yu-Tsan Chia, Tien-Shui Chen (TW)

Correspondence Address: MERCHANT & GOULD PC, P.O. BOX 2903, MINNEAPOLIS, MN, 55402-0903, US

(73) Assignee: ADVANCED CONNECTION TECHNOLOGY INC., Tien-Shui Chen (TW)

(21) Appl. No.: 12/015,969

(22) Filed: Jan. 17, 2008

(51) Int. Cl. G06Q 30/00

(52) U.S. Cl. 705/14; 705/26; 705/27

(57) ABSTRACT

A network transaction intermediating method is adapted to be executed by a network platform. The network platform provides basic product data to a buyer terminal upon receipt of a product inquiry request from the buyer terminal, and transmits a connection command to the buyer terminal in response to selection of any one entry of the basic product data at the buyer terminal to enable the buyer terminal to connect to a corresponding vendor terminal of the selected entry of the basic product data so as to obtain the product introduction data corresponding to the selected entry of the basic product data. Thus, the transmission of the product introduction data can be made more efficient.

### BACKGROUND OF THE INVENTION

1. Field of the Invention

The invention relates to a network transaction intermediating method and a network platform therefor, more particularly to a network transaction intermediating method employing peer-to-peer technology, and a network platform therefor.

2. Description of the Related Art

Due to advantages of convenience, immediacy, and timeliness provided by networks, the amount of business transacted over networks has increased considerably in recent years. Both the vendor and the buyer have gradually become used to looking for potential customers or required products on networks.

Currently, there are a number of network platforms which provide network transaction intermediary services, such as Yahoo!, PC Home, etc. Such transaction platforms allow a vendor to upload product data to a server of a network platform, and allow a buyer to log into the network platform to browse various product data on the transaction platforms. For effective product introduction, in addition to product names, model numbers, prices, vendor names, and contact information, the product introduction data generally include video, animation, and the like. However, such product introduction data are usually large in terms of data size. Consequently, it takes much time to upload the data on the vendor side, and it takes much time for downloading when a prospective buyer wants to browse the data. Moreover, a network platform usually imposes an upper limit on the amount of uploaded product introduction data. Furthermore, the network platform requires more storage space for storing the product data, and needs a larger bandwidth to enable the vendor and the buyer to enjoy a more efficient network connection speed, thereby increasing business operational costs.

### SUMMARY OF THE INVENTION

Given that the network technique adopted by conventional network platforms is a centralized type, i.e., all the product data are stored on the network platform, uploading or downloading of product data at the vendor side or at the buyer side requires connection to the network platform, thereby giving rise to the aforesaid problems. Therefore, this invention contemplates the use of a decentralized network technique by employing peer-to-peer (hereinafter referred to P2P) technology, whereby product introduction data of a large amount are stored at a vendor terminal, and a buyer terminal can be directly connected to the vendor terminal using P2P network technology to download the product introduction data when the user of the buyer terminal desires to browse the product introduction data. Thus, not only can the speed of transmitting the product introduction data be improved, load of the network platform can also be reduced.

Therefore, the object of the present invention is to provide a network transaction intermediating method that permits more efficient transmission of product introduction data, and a network platform therefor.

Accordingly, a network transaction intermediating method of this invention is adapted to be executed by a network platform. The network platform stores a plurality of entries of product data. Each entry of the product data is associated with a corresponding vendor terminal, and includes basic product data. The vendor terminal stores product introduction data corresponding to the product data. The network transaction intermediating method includes the following steps:

(A) when a product inquiry request is received from a buyer terminal, providing to the buyer terminal the basic product data of the product data corresponding to the product inquiry request; and

(B) in response to selection of an entry of the basic product data by a user of the buyer terminal, transmitting a connection command to the buyer terminal to enable the buyer terminal to download the corresponding product introduction data from the vendor terminal to which the selected entry of the basic product data corresponds.

In the present invention, the product introduction data are provided using a decentralized network technique, and the buyer terminal can be connected directly to the vendor terminal using P2P technology to browse the product introduction data, thereby enhancing the efficiency of the transmission of the product introduction data.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic diagram to illustrate the preferred embodiment of a network platform according to the present invention, the network platform being used by a prospective buyer and a vendor;

FIG. 2 is a flowchart to illustrate a product inquiry flow in the preferred embodiment of a network transaction intermediating method according to the present invention;

FIG. 3 illustrates an example of basic product data provided in the product inquiry flow of the preferred embodiment; and

FIG. 4 is a flowchart to illustrate a product registration flow in the preferred embodiment.

### DETAILED DESCRIPTION OF THE PREFERRED EMBODIMENT

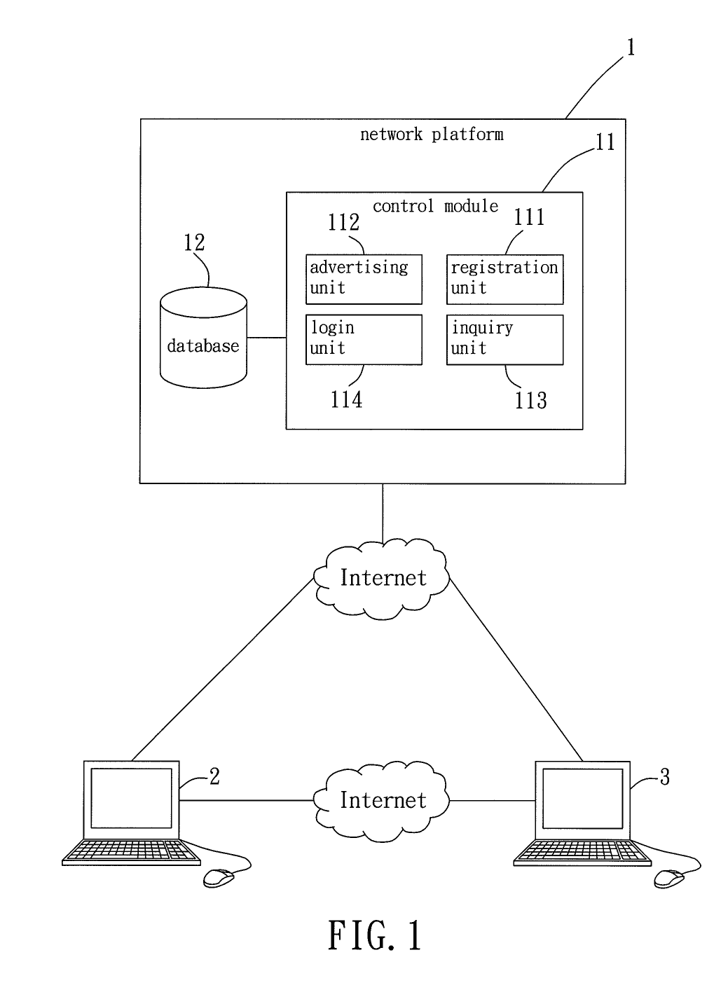

In order to overcome the inconveniences associated with centralized storage of product introduction data, the present invention permits a buyer terminal of a user interested in viewing product introduction data to directly connect to a vendor terminal of a vendor to view such data. Referring to FIG. 1, a network platform 1 for network transactions is executed by a server, and primarily includes a control module 11 for coordinating operation of the network platform 1, and a database 12. The network platform 1 permits a buyer terminal 2 or a vendor terminal 3 to connect thereto for browsing or submission of product data. To facilitate description, the present invention will be exemplified using a single buyer terminal 2 and a single vendor terminal 3 in this embodiment. However, those skilled in the art will appreciate that the number of the buyer terminal 2 and the number of the vendor terminal 3 may vary and shall not be limited by the disclosure herein. The database 12 stores a plurality of entries of product data. Each entry of the product data is associated with a corresponding vendor terminal 3, and includes basic product data, product serial number, exclusive identification data of the vendor terminal 3, and basic vendor data. The basic product data include a product name, a product model number, a selling price, service life, etc., which are inputted by the user of the vendor terminal 3 to define attributes of the product. The identification data are exclusive unique identification data of the vendor terminal 3 on the Internet to enable other parties to locate the vendor terminal 3 using the identification data. The identification data may be an IP address. The basic vendor data include a vendor name, methods of delivery such as courier, post, hand delivery, etc., and vendor contact information such as address, phone number, email address, etc. To enable the user of the buyer terminal 2 to search the product data by category, the product data in this embodiment further include “category” and “location.” Types of categories are provided by the network platform 1 to enable the user of the vendor terminal 3 to sort the products thereof by corresponding categories, e.g., display, mobile phone, small household appliance, notebook computer, etc. “Location” refers to the location of the product being sold, such as Taiwan, United States, Mainland China, etc., which are also provided by the network platform 1 for selection by the user of the vendor terminal 3.

To facilitate management by the network platform 1, the network platform 1 of this embodiment further requires the user, whether it is the user of the buyer terminal 2 or the user of the vendor terminal 3, to register as a member of the network platform 1 in order to be able to use the product data browsing or registering function of the network platform 1. Therefore, the database 12 further stores user data inputted by the user of the buyer terminal 2 and the user of the vendor terminal 3 on registration. When the buyer terminal 2 or the vendor terminal 3 is connected to the network platform 1, a registration unit 111 of the control module 11 of the network platform 1 will require the user of the buyer terminal 2 or the user of the vendor terminal 3 to log in and to input registration data for authentication against the user data. Moreover, the registration unit 111 further provides a registration function to allow the user of the buyer terminal 2 or the user of the vendor terminal 3 who is not yet a member of the entity providing the network platform 1 to register as a member and to input user data.

Furthermore, in order to increase the revenue of the network platform 1, the database 12 further stores a plurality of entries of advertising data, and the control module 11 further includes an advertising unit 112. When the user of the buyer terminal 2 or the user of the vendor terminal 3 browses web pages of the network platform 1, the advertising unit 112 of the control module 11 will timely retrieve the advertising data for display on the web pages.

The control module 11 of this embodiment further includes an inquiry unit 113 which, upon receipt of a product inquiry request from the buyer terminal 2, retrieves the corresponding product data from the database 12 and provides the basic product data and the basic vendor data to the buyer terminal 2. The inquiry unit 113 further transmits a connection command to the buyer terminal 2 in response to selection of any one entry of the basic product data by the user of the buyer terminal 2. The connection command includes the identification data of the vendor terminal 3 and the product serial number associated with the selected basic product data. The buyer terminal 2 is automatically connected to the vendor terminal 3 to download the product introduction data corresponding to the selected basic product data upon receipt of the connection command. The control module 11 further includes a login unit 114 which, upon receipt of a product registration request from the vendor terminal 3, provides an interface for the user of the vendor terminal 3 to input the product data and to store the product data in the database 12.

The buyer terminal 2 and the vendor terminal 3 can be connected to the network platform 1 through the Internet, or to each other through the Internet. The buyer terminal 2 and the vendor terminal 3 in this embodiment are computers, each of which has exclusive identification data (e.g., an IP address), so as to enable the buyer terminal 2 and the vendor terminal 3 to transmit data to each other over the Internet using P2P technology. The P2P data transmission function can be executed by installing software in the buyer terminal 2 and the vendor terminal 3. The buyer terminal 2 and the vendor terminal 3 can locate each other and transmit data to each other over the Internet as long as they have the identification data of each other. Thus, the buyer terminal 2 can use the identification data in the connection command to send a product introduction data request containing the product serial number of the selected basic product data to the vendor terminal 3 upon receipt of the connection command from the inquiry unit 113. The vendor terminal 3 further stores the product introduction data corresponding to the product data that the user of the vendor terminal 3 has registered with the network platform 1. The product introduction data are multimedia images, and include at least one of pictures and videos. When the vendor terminal 3 receives the product introduction data request from the buyer terminal 2, the vendor terminal 3 will transmit the corresponding product introduction data to the buyer terminal 2.

The network transaction intermediating method provided by the network platform 1 in this embodiment will be described hereinbelow. It is first noted that a user can submit a product registration request or a product inquiry request after logging into the network platform 1 to act as a prospective buyer or a vendor. While the prospective buyer and the vendor are depicted as different users in this embodiment to facilitate description of the present invention, those skilled in the art shall appreciate that a user can be both the prospective buyer and the vendor at the same time.

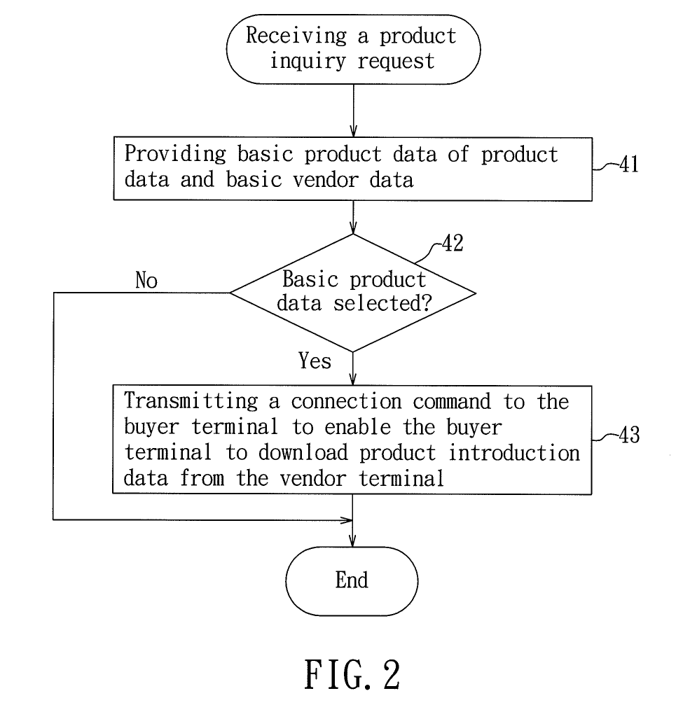

The flow of a product data inquiry conducted by the buyer terminal 2 is illustrated with reference to FIG. 2, wherein the inquiry flow is initiated when the network platform 1 receives a product inquiry request from the buyer terminal 2 after a successful authentication, and is executed by the inquiry unit 113. The product inquiry request may include at least one of a keyword, a category, and a location. The user of the buyer terminal 2 may set the content of the product inquiry request according to the requirement thereof.

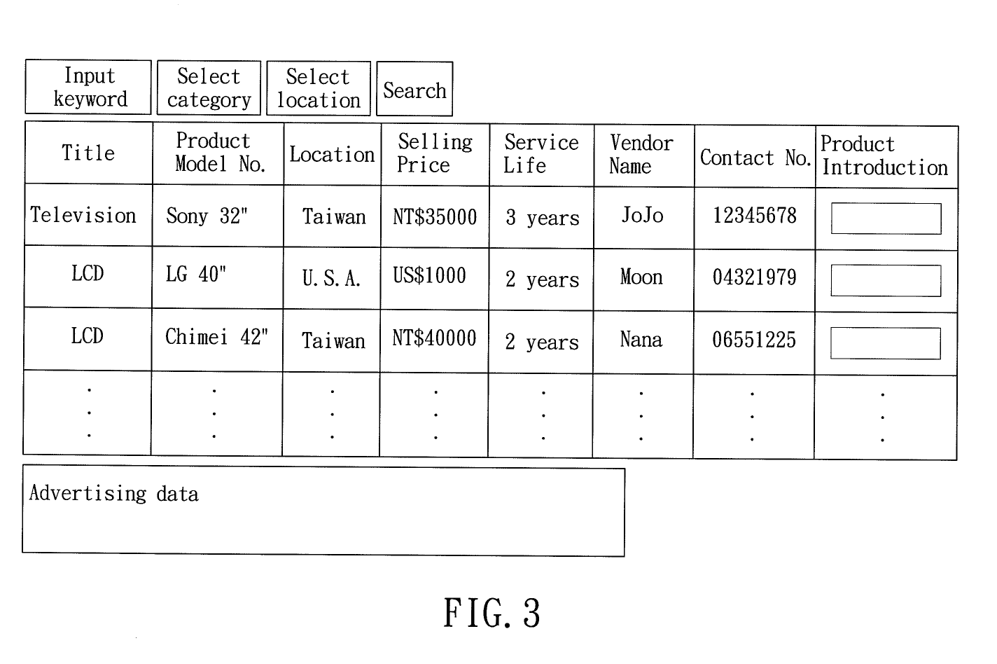

In step 41, the inquiry unit 113 of the control module 11 retrieves corresponding product data from the database 12 according to the product inquiry request, and provides the basic product data of the retrieved product data to the buyer terminal 2. At this time, the inquiry unit 113 may further provide the basic vendor data corresponding to the retrieved product data to the buyer terminal 2. The advertising unit 112 will also retrieve from the data base 12 the advertising data which, together with the basic product data retrieved by the inquiry unit 113, are provided to the buyer terminal 2. To enable the user of the buyer terminal 2 to better understand a product of interest, the inquiry unit 113 transmits a connection command to the buyer terminal 2 in response to selection of an entry of the basic product data by the user of the buyer terminal 2. The basic product data, the basic vendor data, and the advertising data are provided to the buyer terminal 2 by displaying on web pages. Each entry of the basic product data further includes a product introduction option for selection by the user of the buyer terminal 2 so as to select the basic product data. The inquiry unit 113 will correspondingly generate a connection command to the buyer terminal 2 in response to selection of the product introduction option so as to enable the buyer terminal 2 to connect to the vendor terminal 3 to download the corresponding product introduction data. For instance, as shown in FIG. 3, if the user of the buyer terminal 2 has selected the category of display in the product inquiry request for the search, the inquiry unit 113 will provide all the basic product data in the database 12 which belong to the category of display, as well as the corresponding basic vendor data, to the buyer terminal 2. Furthermore, in addition to providing the basic product data, the inquiry unit 113 will provide the location information for each entry of the product data to inform the user of the buyer terminal 2 where the concerned product is located. Thus, the user of the buyer terminal 2 can browse the displayed basic product data and the basic vendor data. If the user of the buyer terminal 2 is interested in getting more information on any one entry of the basic product data, he/she can use the cursor to select the product introduction option corresponding to that entry of the basic product data.

In step 42, the inquiry unit 113 determines whether any one entry of the basic product data is selected, i.e., whether any product introduction option is selected. In the affirmative, step 43 is executed. In the negative, the current product inquiry flow can be ended according to the requirement of the user of the buyer terminal 2, so that the buyer terminal 2 can proceed with a next product inquiry flow.

In step 43, the inquiry unit 113 generates a connection command to be transmitted to the buyer terminal 2. The connection command includes the identification data of the vendor terminal 3 and the product serial number so as to drive the buyer terminal 2 to connect to the vendor terminal 3 to download the corresponding product introduction data for browsing. Specifically, upon receipt of the connection command, the buyer terminal 2 will send a product introduction data request containing the product serial number of the selected basic product data directly to the vendor terminal 3 according to the identification data in the connection command. The vendor terminal 3 will send the corresponding product introduction data to the buyer terminal 2 upon receipt of the product introduction data request, so that the buyer terminal 2 can directly connect to the vendor terminal 3 to download the corresponding product introduction data. After step 43 is ended, the product inquiry flow can be ended under the control of the user of the buyer terminal 2.

Accordingly, the inquiry unit 113 provides the user of the buyer terminal 2 with product data in stages. For instance, the inquiry unit 113 merely provides the basic product data and the basic vendor data in step 41. Because the amount of the basic product data is relatively small, the basic product data and the basic vendor data can be quickly provided to the buyer terminal 2, and the user of the buyer terminal 2 can use the basic product data to do a preliminary screening to pick out a product of possible interest. For the product of interest to the user of the buyer terminal 2, the inquiry unit 113 further provides the connection command to the buyer terminal 2, so that the buyer terminal 2 can be connected to the vendor terminal 3 to download the corresponding product introduction data using P2P technology. Thus, the buyer terminal 2 acquires the product introduction data directly from the vendor terminal 3 using a decentralized network technique, thereby enhancing the transmission speed of the product introduction data. Moreover, since the product introduction data are stored at the vendor terminal 3, the vendor terminal 3 is no longer limited by the requirement of the network platform 1, and can provide more detailed product introduction data to the buyer terminal 2 for effective promotion. Furthermore, since the product introduction data are stored at the vendor terminal 3 and are provided to the buyer terminal 2 directly by the vendor terminal 3, the load of the network platform 1 can also be reduced.

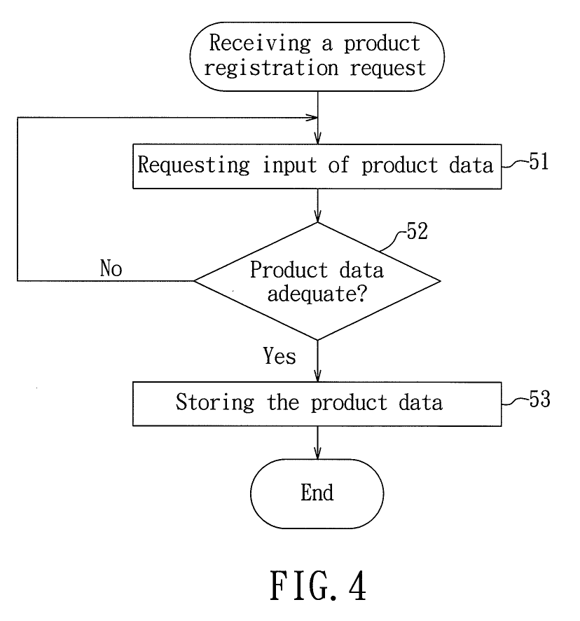

The product registration flow of the network platform 1 will now be illustrated with reference to FIG. 4. The product registration flow is initiated when the network platform 1 receives a product registration request from the vendor terminal 3.

Initially, in step 51, the login unit 114 requests the user of the vendor terminal 3 to input the product data. The product data includes the basic product data, the exclusive identification data of the vendor terminal 3, the basic vendor data, category, location, etc. The login unit 114 in this embodiment displays on a web page items that require input of product data by the vendor via the vendor terminal 3. At the same time, the advertising unit 112 displays advertising data on the web page. After step 51 is ended, i.e., after the user of the vendor terminal 3 has inputted the product data, step 52 is executed, in which the login unit 114 confirms whether the inputted product data are adequate, i.e., confirming whether the inputted product data include requisite items such as the basic product data, the identification data, the basic vendor data, category, location, etc. If it is determined to be yes in step 52, the login unit 114 executes step 53 to store the current entry of product data in the database 12, and the current product registration flow is ended. On the contrary, if it is determined to be no in step 52, the flow returns to step 51 to require the user of the vendor terminal 3 to input product data so as to ensure the adequacy of the product data.

In sum, in the network transaction intermediating method of the present invention, the network platform 1 provides the basic product data and the basic vendor data which are of a small data amount to the buyer terminal 2, and the buyer terminal 2 can use the connection command from the network platform 1 to connect directly to the vendor terminal 3 using P2P technology to obtain the corresponding product introduction data if the user of the buyer terminal 2 is interested in a product. Not only can the load of the network platform 1 be reduced considerably, the user of the buyer terminal 2 can quickly obtain the product introduction data from the vendor terminal 3 via a decentralized network. Thus, the transmission efficiency of product introduction data can be enhanced, and the user of the vendor terminal 3 is not subject to the constraint of the network platform 1, and can provide more informative product introduction data to increase chances of selling the product.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. A network transaction intermediating method adapted to be executed by a network platform, the network platform storing a plurality of entries of product data, each entry of the product data being associated with a corresponding vendor terminal and including basic product data, the vendor terminal storing product introduction data corresponding to the product data, the network transaction intermediating method comprising the following steps:
(A) when a product inquiry request is received from a buyer terminal, providing to the buyer terminal the basic product data of the product data corresponding to the product inquiry request; and
(B) in response to selection of an entry of the basic product data by a user of the buyer terminal, transmitting a connection command to the buyer terminal to enable the buyer terminal to download the corresponding product introduction data from the vendor terminal to which the selected entry of the basic product data corresponds.

2. The network transaction intermediating method according to claim 1, wherein the product introduction data are multimedia images.

3. The network transaction intermediating method according to claim 2, wherein the multimedia images are one of pictures and videos.

4. The network transaction intermediating method according to claim 1, wherein the connection command includes identification data of the vendor terminal to which the selected entry of the basic product data corresponds.

5. The network transaction intermediating method according to claim 4, wherein each entry of the product data further includes a product serial number, the connection command further including the product serial number to which the selected entry of the basic product data corresponds.

6. The network transaction intermediating method according to claim 1, wherein each entry of the product data further includes basic vendor data, the basic vendor data including a vendor name and vendor contact information, and wherein step (A) further includes providing to the buyer terminal the basic vendor data of the product data corresponding to the product inquiry request.

7. The network transaction intermediating method according to claim 1, wherein each entry of the product data includes a category, and wherein, in step (A), the product inquiry request includes a selected category, and the basic product data of the product data whose category matches the selected category are provided to the buyer terminal.

8. The network transaction intermediating method according to claim 1, wherein each entry of the product data includes a location, and wherein, in step (A), the product inquiry request includes a selected location, and the basic product data of the product data whose location matches the selected location are provided to the buyer terminal.

9. The network transaction intermediating method according to claim 1, further comprising a step (C) of requiring a user of the vendor terminal to input the product data for storage on the network platform upon receipt of a product registration request from the vendor terminal, and inspecting the product data for adequacy prior to storage, the user of the vendor terminal being requested to input additional product data if the inputted product data are insufficient.

10. The network transaction intermediating method according to claim 1, further comprising a step (D) of providing advertising data to one of the buyer terminal and the vendor terminal when said one of the buyer terminal and the vendor terminal is connected to the network platform.

11. A network platform, comprising:
a database storing at least one entry of product data, the entry of the product data being associated with a vendor terminal and including basic product data and exclusive identification data of the vendor terminal; and
a control module including an inquiry unit that provides the basic product data of the product data upon receipt of a product inquiry request from a buyer terminal, and that transmits a connection command to the buyer terminal in response to selection of an entry of the basic product data of the product data by a user of the buyer terminal so as to enable the buyer terminal to download the product introduction data to which the selected entry of the basic product data corresponds from the vendor terminal providing the selected entry of the basic product data.

12. The network platform according to claim 11, wherein each entry of the product data in said database further includes basic vendor data, the basic vendor data including a vendor name and vendor contact information, said inquiry unit further providing to the buyer terminal the basic vendor data of the product data corresponding to the product inquiry request.

13. The network platform according to claim 11, wherein said control module further includes a login unit which requires a user of the vendor terminal to input the product data for storage in said database upon receipt of a product registration request from the vendor terminal.

14. The network platform according to claim 13, wherein said database further stores a plurality of entries of advertising data, and said control module further includes an advertising unit which provides the advertising data to one of the buyer terminal and the vendor terminal when said one of the buyer terminal and the vendor terminal is connected to the network platform.
